(19) United States
(12) Patent Application Publication
(10) Pub. No.: US 2015/0036570 A1
(43) Pub. Date: Feb. 5, 2015

(54) METHOD AND APPARATUS FOR TRANSMISSION SCHEDULING IN WIRELESS SENSOR NETWORK

(71) Applicants: Yonsei University, Univesity -Industry Foundation (UIF), Seoul (KR); Electronics and Telecommunications Research Institute, Daejeon (KR)

(72) Inventors: Hoon JEONG, Daejeon (KR); Gwan Joong KIM, Daejeon (KR); Jong Moon CHUNG, Seoul (KR); Donghyuk HAN, Seoul (KR); Sang-Joon NAM, Seoul (KR)

(73) Assignees: Yonsei University, Univesity -Industry Foundation (UIF), Seoul (KR); Electronics and Telecommunications Research Institute, Daejeon (KR)

(21) Appl. No.: 14/143,808

(22) Filed: Dec. 30, 2013

(30) Foreign Application Priority Data
Aug. 2, 2013 (KR) 10-2013-0092021

(51) Int. Cl. H04W 52/02; H04W 84/18

(52) U.S. Cl. CPC H04W 52/0216; H04W 84/18
USPC 370/311

(57) ABSTRACT

In a sensor network including a sink node and a plurality of sensor nodes, the sink node receives a routing message including routing information from the sensor nodes, analyzes a structure of the sensor network based on routing information, and calculates a transmission schedule of each sensor node based on the analyzed network structure. Schedule information according to the calculated transmission schedule includes a wakeup time of the sensor node, a time interval that is consumed for packet transmission, and a standby time for preventing a packet collision based on the time interval.

### CROSS-REFERENCE TO RELATED APPLICATION

This application claims priority to and the benefit of Korean Patent Application No. 10-2013-0092021 filed in the Korean Intellectual Property Office on Aug. 2, 2013, the entire contents of which are incorporated herein by reference.

### BACKGROUND OF THE INVENTION

(a) Field of the Invention

The present invention relates to a method and apparatus for transmission scheduling in a sensor network.

(b) Description of the Related Art

For quick monitoring of a sensing target in a wireless environment management sensor network, fast transmission in which latency is minimized and transmission of accurate sensing information in which interference is minimized is essentially required, and small energy consumption is also required.

In an existing wireless sensor network, sensing information that is formed with a packet of a small size frequently occurs, and in order to transmit/receive the entirety of such sensing information, an idle-listening time that is much longer than an actual transmission and reception time is used. However, because a method of using an idle-listening time is very inefficient, in a wireless sensor network in which energy consumption becomes an important point, further improved media access control (MAC) protocols are required.

A MAC protocol using in a wireless sensor network includes S-MAC. In the S-MAC, each sensor node follows a periodic sleep/listen schedule. In a transmission mechanism of the S-MAC, a sender node transmits a packet to a destination node. A listening cycle, which is an active segment of each node, is divided into a SYNC cycle and a data cycle, and for the SYNC cycle, while a clock of each node is synchronized according to an independent synchronization protocol, each node is simultaneously woken up with an adjacent node and receives a packet for the data cycle.

In such an S-MAC protocol, in order to avoid a collision due to simultaneous transmission between several nodes, a request to send/clear to send (RTS/CTS) mechanism is used, and when a packet is received from another node, the node responds to a node that sends acknowledgement (ACK).

However, a MAC protocol of such a typical wireless sensor network is focused and designed in a direction that reduces energy consumption and thus has much limitation. A typical limitation is an increase of end-to-end delivery latency. According to S-MAC, because a packet is forwarded based on 1 hop, a situation in which a node that performs a relay function at the intermediate should wait until a next node wakes up occurs. Further, in the S-MAC, because a node is almost simultaneously woken up while being synchronized with an adjacent node, a possibility in which a collision may occur in a network increases. In addition to such a limitation, in view of a characteristic of a sensor network that collects information of a specific monitoring target, when a sudden change is detected, information thereof should be forwarded to a user as quickly as possible. Therefore, in addition to a design for decreasing energy consumption, a design of a MAC protocol and a scheduling method that can reduce end-to-end delivery latency are required.

A routing enhanced MAC (RMAC) protocol is designed in consideration of limitations in the above-described wireless sensor network. RMAC shows smaller latency smaller than that of S-MAC and improvement in energy consumption performance in consideration of an energy consumption decrease while solving end-to-end delivery latency and collision problems.

The most important characteristic of RMAC is to forward data to several hops within one operation cycle, and this is a characteristic that is distinguished from the previous S-MAC. Intermediate relay nodes are in a sleep state for a sleep cycle, and when a previous step node of a relay has a packet to forward and forwarding of the packet is prepared, the intermediate relay nodes are intelligently woken up. When a packet is received without a waiting time through such a method, the intermediate relay node may forward a packet to a next node.

Further, in RMAC, packet forwarding of several nodes instead of transmission/reception of a pair of nodes is available within one sleep cycle, and thus congestion control performance is improved. While a small control frame is relayed to all nodes through a packet forwarding path, improvements of such a performance are caused by previously searching whether a packet may be received from a superordinate relay node without waiting for a wakeup time point of nodes.

In such RMAC, when entering a data cycle, a sender node transmits a control frame that is referred to as a pioneer frame (PION) through a multi-hop path. When the PION is transmitted and relayed, all nodes are in a wakeup state, and after this procedure finishes, nodes that the PION passes through in a multi-hop path are in a scheduled state to be in a sleep state and a wakeup state at an effective time. Therefore, nodes individually perform wakeup and sleep from that time. Therefore, nodes that the PION passes through are in a woken-up state only when transmitting/receiving or relaying according to scheduling, and enter a sleep state and are in a sleep cycle in the remaining cases.

Through characteristics that are specialized in a multi-hop network of RMAC that performs wakeup/sleep scheduling of nodes in a multi-hop path by previously relaying PION, excellent performance can be obtained in view of energy use efficiency and end-to-end delivery latency compared to the existing S-MAC.

However, in a wireless sensor network that is specialized for a water environment management, i.e., in a wireless sensor network that is formed with node disposition of a linear form or node disposition of a tree form, optimal scheduling is not performed. For example, in a water environment management wireless sensor network in which nodes are linearly disposed in a river area or in which nodes are disposed in a tree form at a river junction, information that is sensed in each node is relayed through nodes and is gathered to a sink node, and technology development on a protocol and scheduling algorithm that is optimized for such a network structure are relatively unprepared. Particularly, a scheduling algorithm that is related to a MAC protocol that reduces a load of a junction node in consideration of a network structure of a tree form in addition to a linear multi-hop relay structure and that operates based on competition without a beacon has not been suggested.

### SUMMARY OF THE INVENTION

The present invention has been made in an effort to provide a method and apparatus for transmission scheduling having advantages of minimizing delivery latency in a wireless sensor network in which nodes are disposed in a linear or tree form requiring multi-hop relay transmission.

The present invention has been made in an effort to further provide a method and apparatus for transmission scheduling having advantages of reducing a load that is applied to a junction node in a wireless sensor network.

An exemplary embodiment of the present invention provides a method in which a sink node performs transmission scheduling in a sensor network including the sink node and a plurality of sensor nodes, the method including: receiving, by the sink node, a routing message including routing information from the sensor nodes; analyzing, by the sink node, a structure of the sensor network based on the routing information and calculating a transmission schedule of each sensor node based on the analyzed network structure; and transmitting a schedule message including schedule information according to the calculated transmission schedule to the sensor nodes, wherein the schedule information includes a wakeup time of the sensor node, a time interval that is consumed for transmitting a packet, and a standby time for preventing a packet collision based on the time interval.

The schedule information may further include a hop number and a node number from the sensor node to the sink node.

The standby time may be xγ′, where γ′ represents a time interval and the x may satisfy a condition of 3≦x≦X.

The calculating of a transmission schedule may include calculating, when the sensor network includes a plurality of routing path branches based on a junction node: the node number on a routing path branch basis; and calculating a transmission schedule on a routing path branch basis according to a priority order based on the node number.

The method may further include calculating a transmission schedule of sensor nodes that are included in each branch in order from a branch having the smallest node number.

The schedule message may be formed based on a pioneer frame (PION frame) structure, and may include an initial transmission schedule field including an initial value of a wakeup time of the sensor node, an interfacing time information field including a time interval and a standby time that are consumed for transmitting a packet, and a hop count field representing an end-to-end hop number.

Another embodiment of the present invention provides a method in which a sensor node performs transmission scheduling in a sensor network including a sink node and a plurality of sensor nodes, the method including: receiving, by a sensor node, a schedule message including schedule information from the sink node; and determining a wakeup time for transmitting/receiving data based on the schedule information, wherein the schedule information includes an initial value of a wakeup time of the sensor node, a time interval that is consumed for transmitting a packet, and a hop number and a node number from the sensor node to the sink node.

In the determining of a wakeup time, the wakeup time may be determined as T_{wakeup}←₀+(N−h−1)·γ′, where γ′ is a time interval, N is the node number, t₀ is the initial value, and h is the hop number.

The method may further include: waking up, by the sensor node, at the wakeup time and detecting a channel; determining, when a packet to perform relay transmission exists at the channel, a transmitting time of the relay packet; and determining a schedule time to receive a next packet.

The determining of a transmitting time may include determining the transmitting time based on the determined wakeup time and the time interval, and the determining of a schedule time may include determining the schedule time based on the determined wakeup time and the standby time.

The method may further include determining, when the sensor node generates a packet to transmit, a transmitting time for transmitting the generated packet, after the waking up at the wakeup time, wherein a transmitting time for transmitting the generated packet may be determined based on the standby time.

A sensor node that is positioned at a terminal of the sensor network may first start data transmission, and adjacent sensor nodes existing within the predetermined hop number from a sensor node that performs data transmission may not perform data transmission when the sensor nodes are disposed in a linear structure in the sensor network.

Data transmission may be performed in order of a branch having the smallest node number, and after data transmission of sensor nodes belonging to a random branch is complete, data transmitting of sensor nodes belonging to a branch of a next order may be performed, when sensor nodes are disposed while forming at least one branch based on a junction node according to a tree structure in the sensor network.

The method may further include transmitting, by the sensor node, a routing message including routing information to the sink node, before receiving of a schedule message, wherein the routing information may include the transmitting hop number to the sink node according to a routing path, an address or identification information of the sensor node, and identification information of an upward node.

Yet another embodiment of the present invention provides a scheduling apparatus that performs transmission scheduling in a sensor network including a sink node and a plurality of sensor nodes, the scheduling apparatus including: a wireless communication unit that performs communication with nodes that are positioned at a periphery; a transmitting power controller that determines transmitting power of the wireless communication unit based on channel state information that is provided from nodes; a network analysis unit that analyzes a network structure based on routing information that is received from nodes; and a schedule calculator that calculates a node number on a routing path branch basis that is acquired based on the network structure and that calculates a transmission schedule in order of a branch having the smallest node number.

The schedule calculator may generate schedule information including a wakeup time of a sensor node, a time interval that is consumed for transmitting a packet, and a standby time for preventing a packet collision based on the time interval, and may transmit the schedule information to the sensor node through the wireless communication unit.

The routing information may include a transmitting hop number to the sink node according to a routing path, an address or identification information of the sensor node, and identification information of an upward node, and the network analysis unit may acquire routing path branches that are connected to a junction node based on the routing information.

### BRIEF DESCRIPTION OF THE DRAWINGS

FIG. 1 is a diagram illustrating a sensor network according to an exemplary embodiment of the present invention.

FIG. 2 is a diagram illustrating time that is consumed for transmitting data when a reply of an ACK packet is not requested, and FIG. 3 is a diagram illustrating a time that is consumed for transmitting data when a reply of an ACK packet is requested.

FIG. 4 is a flowchart illustrating a method of transmitting data in a wireless sensor network according to an exemplary embodiment of the present invention.

FIG. 5 is a diagram illustrating a pseudo code representing operation of a sink node according to the method of transmitting data of FIG. 4.

FIG. 6 is a flowchart illustrating a scheduling method that a sink node performs according to an exemplary embodiment of the present invention, and

FIG. 7 is a diagram illustrating a pseudo code representing operation of the sink node according to the scheduling method of FIG. 6.

FIG. 8 is a diagram illustrating a structure of a schedule message according to an exemplary embodiment of the present invention.

FIG. 9 is a flowchart illustrating a scheduling method that a general node performs according to an exemplary embodiment of the present invention, and

FIG. 10 is a diagram illustrating a pseudo code representing operation of a general node according to the scheduling method of FIG. 9.

FIG. 11 is a diagram illustrating a structure of a routing message according to an exemplary embodiment of the present invention.

FIG. 12 is a message flowchart of a network according to a scheduling method according to an exemplary embodiment of the present invention.

FIG. 13 is a block diagram illustrating a structure of a scheduling apparatus according to an exemplary embodiment of the present invention.

FIG. 14 is a diagram illustrating data transmission timing when a scheduling method is applied to a sensor network of a tandem structure according to an exemplary embodiment of the present invention.

FIG. 15 is a diagram illustrating data transmission timing when a scheduling method is applied to a sensor network having a bonding node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a method and apparatus for scheduling a packet in a wireless sensor network according to an exemplary embodiment of the present invention will be described with reference to the drawings.

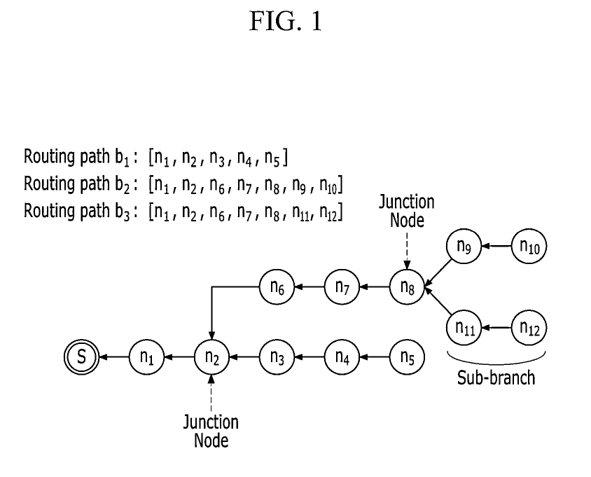

FIG. 1 is a diagram illustrating a sensor network according to an exemplary embodiment of the present invention.

Referring to FIG. 1, the sensor network includes a sink node S and a sensor node, for example, sensor nodes n₁, n₂, n₃, . . . , n₁₂, which are a plurality of general nodes.

The sensor nodes n₁, n₂, n₃, . . . , n₁₂ collect environment or situation information within a sensing area thereof and transmit collected data to the sink node S. The sensor nodes n₁, n₂, n₃, . . . , n₁₂ may be separated by 1 hop from the sink node S and may be separated by at least 2 hops from the sink node S. Here, a distance through which power of any one sensor node arrives may be defined as 1 hop. Therefore, the sensor nodes n₁, n₂, n₃, . . . , n₁₂ may transmit data that is collected through hop communication to the sink node S. For example, the sensor node n₃ may transmit data that is collected through multi-hop communication through the sensor nodes n₁ and n₂ to the sink node S.

The sink node S manages and controls the sensor nodes n₁, n₂, n₃, n₁₂ that the sink node S charges within a sensor network and transmits data that is collected from each sensor node to a server (not shown).

In a sensor network that is formed in such a structure, it is assumed that all nodes transmit with minimum transmitting power to satisfy a minimum signal to interference plus noise ratio (SINR) of a 1-hop node based on channel state information (CSI) that gives and receives when forming a network. Further, in a carrier sense multi-hop access with collision avoidance (CSMA/CA)-based network, a time interval γ′ that is consumed for transmitting one packet is changed according to whether an acknowledgment (ACK) packet is requested.

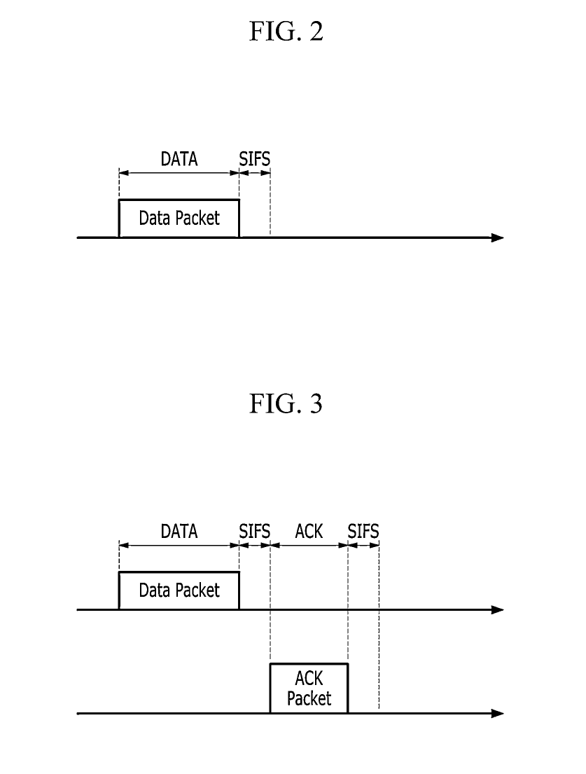

FIG. 2 is a diagram illustrating a time that is consumed for transmitting data when a reply of an ACK packet is not requested, and FIG. 3 is a diagram illustrating a time that is consumed for transmitting data when a reply of an ACK packet is requested.

A time interval γ′ that is consumed for transmitting one packet is changed according to whether ACK is replied, as shown in FIGS. 2 and 3, and when an ACK reply is unnecessary, the time interval γ′ has of a value γ′=DATA+SIFS, as shown in FIG. 2, and when an ACK reply is necessary, the time interval γ′ has a value of γ′=DATA+ACK+2·SIFS, as shown in FIG. 3.

A method of transmitting data in a wireless sensor network having such characteristics will now be described.

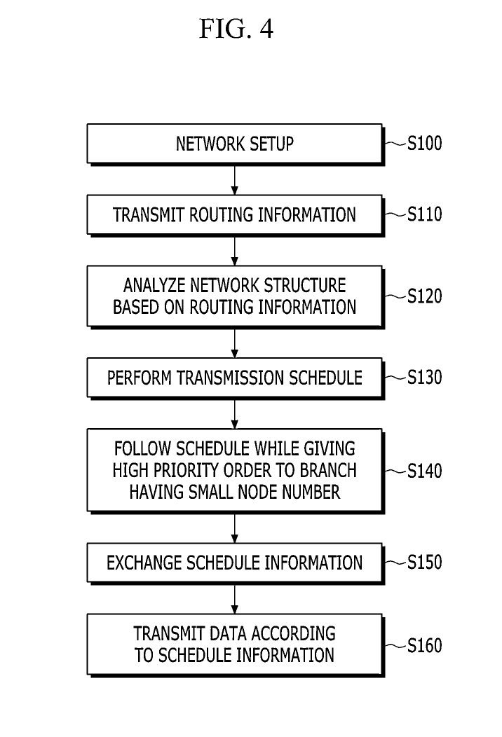

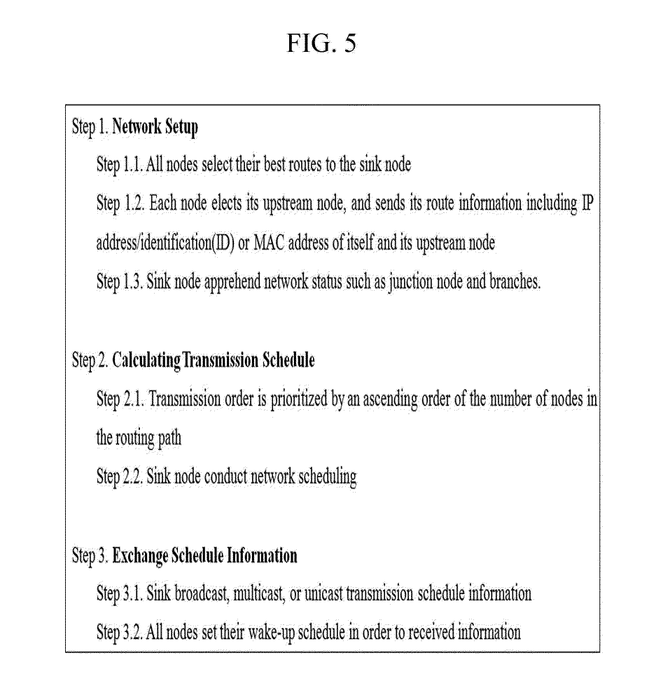

FIG. 4 is a flowchart illustrating a method of transmitting data in a wireless sensor network according to an exemplary embodiment of the present invention. FIG. 5 is a diagram illustrating a pseudo code representing operation of a sink node according to the method of transmitting data of FIG. 4.

A wireless sensor network according to an exemplary embodiment of the present invention illustrates a sensor network for managing a water environment.

Referring to FIGS. 4 and 5, network setup is performed (S100) (step1).

In the network initial forming step, each node constituting a network forms a routing path according to a routing metric that a network designer designates, and transmits routing information including information that is related to a routing path to a sink node according to a defined message form (S110) (step 1.1). For example, each node transmits the transmitting hop number to the sink node according to a routing path, an IP address thereof in an IP-based network (e.g., 6LoWPAN, etc.), and an IP address of an upward node that is used when upstream data with the sink node to the sink node. Alternatively, in a case of a non-IP-based network such as ZigBee, each node transmits the transmitting hop number, identification (ID) thereof or a MAC address, and ID of an upward node to the sink node (Step 1.2).

When it is assumed that nodes know the hop number to the sink node, the nodes include and transmit a value thereof in a packet as the transmitting hop number to the sink node. When nodes do not calculate the hop number, whenever a value of a field in which the transmitting hop number to the sink node of a packet is recorded is transmitted to every hop, a count of the value is increased (e.g., +1), and when a packet arrives at the sink node, the final hop number may be automatically calculated.

The sink node may grasp a junction node and a network structure according to the junction node based on information that is transmitted from each node (S120) (step 1.3), and the sink node may calculate a transmission schedule and transmit the calculated schedule information.

The sink node follows a transmission schedule based on information that is transmitted from each node (S130) (step 2). The sink node gives a transmitting priority order to each network path that is connected to a junction node in a short path order (e.g., in order of the smallest node number), and calculates a transmission schedule of a node within a network (S140) (steps 2.1 and 2.2).

As shown in FIG. 1, in a sensor network, it is assumed that three routing path branches following a junction node n₂ exist. A routing path branch b₁ includes {n₁, n₂, n₃, n₄, n₅}, a routing path branch b₂ includes {n₁, n₂, n₆, n₇, n₈, n₉, n₁₀}, and a routing path branch b₃ includes {n₁, n₂, n₆, n₇, n₈, n₁₁, n₁₂}. Here, {n₉, n₁₀} and {n₁₁, n₁₂} that are connected to the junction node n₈ form sub-branches.

Here, because the node number of the routing path branch b₁ is 5, the node number of a routing path branch b₂ is 7, and the node number of a routing path branch b₃ is 7, a routing path branch b₁ that is formed with n₁˜n₅ has the highest priority. Nodes within a branch having a priority order transmit data according to a transmission scheduling method of a network to be described later. This will be described in detail later.

Next, the sink node exchanges schedule information (S150) (step 3). That is, the sink node transmits schedule information that is calculated by a scheduling method according to an exemplary embodiment of the present invention to be described later to each node within a network (step 3.1).

Each node within a network prepares and performs data transmission and data reception by adjusting a wakeup time thereof according to received schedule information (S160) (step 3.2). Here, nodes of a branch having the highest priority complete data transmission according to a transmission schedule, and then nodes of a branch having a next priority start data transmission. As shown in FIG. 1, the node number of a routing path branch b₂ having a second priority and the node number of a routing path branch b₃ having a third priority are the same. In this case, nodes of a corresponding branch may perform data transmission in order of the lowest or highest number of node ID, IP, or MAC address.

Hereinafter, in a sensor network that transmits/receives data with the above-described method, a transmission scheduling method is described in detail.

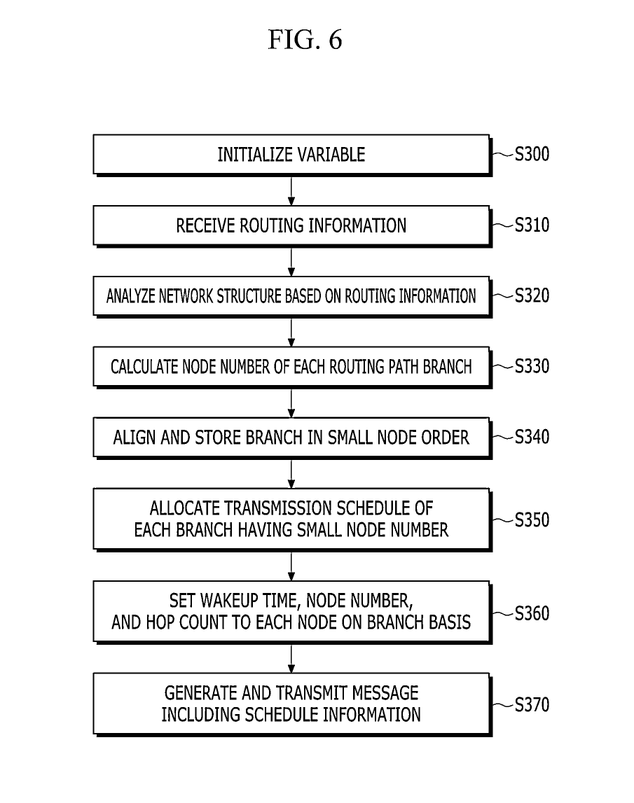

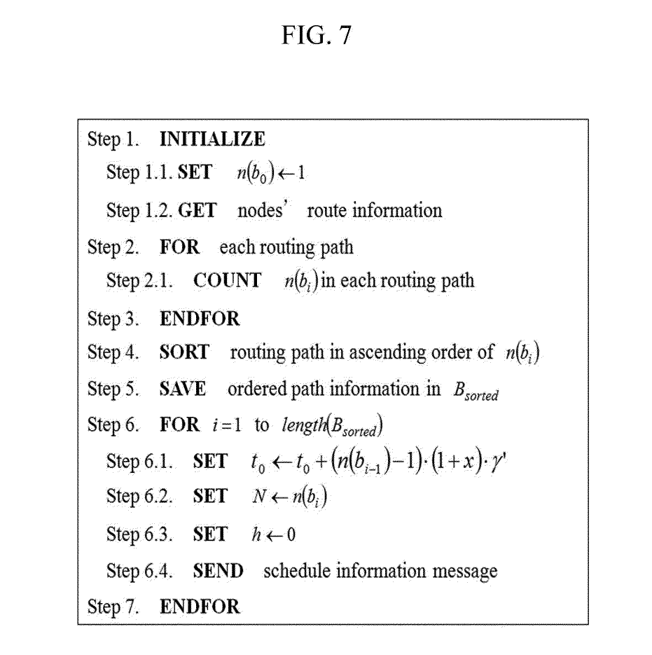

FIG. 6 is a flowchart illustrating a scheduling method that a sink node performs according to an exemplary embodiment of the present invention, and FIG. 7 is a diagram illustrating a pseudo code representing operation of the sink node according to the scheduling method of FIG. 6.

As shown in FIGS. 6 and 7, the sink node initializes variables that are used for calculating scheduling. At an INITIALIZE step, the sink node sets a variable n(b₀) to “1”. The variable n(b₀) represents the node number of a routing path branch (S300).

The sink node receives a routing information message that nodes transmit (S310), and analyzes a network structure and information that is related thereto based on routing information that is included in the received message. The sink node acquires network information including routing path branches according to an analysis result (S320).

The sink node calculates the node number of each routing path branch based on the network information (S330). The sink node calculates the node number n(bᵢ) of a routing path branch bᵢ and corresponds and stores routing path branches to a path information variable B_{sorted} in order of the smallest node number n(bᵢ) (i.e., in order from the smallest number of nodes within a branch) (S340).

Routing path branches are allocated a transmission schedule in ascending order of the node number n(bᵢ). For example, when the node number of a routing path branch b₁ is 5, the node number of a routing path branch b₂ is 7, and the node number of a routing path branch b₃ is 7, each routing path branch is allocated a transmission schedule in order of b₁, b₂, b₃ according to the node number thereof. Therefore, a routing path branch b₁ having the smallest node number has a highest priority order in determining a transmission schedule (S350).

When allocating a transmission schedule, an initial value t₀ of a wakeup time T_{wakeup} of a general node (sensor nodes, except for the sink node) is set. The node number N within each routing path branch is set, and a hop count variable h is set (S360).

An initial value t₀ of a wakeup time T_{wakeup} may be set based on Equation 1.

t₀←t₀+(n(bᵢ₋₁)−1)·(1+x)·γ′ (Equation 1)

Herein, γ′ represents a time interval that is consumed for transmitting one packet. The node number N is set based on the node number n(bᵢ) of each routing path branch, and the hop count variable is initially set as “0”.

In this way, a schedule message including an initial value t₀ of a predetermined wakeup time T_{wakeup} the node number N, and a hop count variable h is generated, and the generated schedule message is transmitted (S370). A time point at which data transmitting/receiving to and from a node is complete may be calculated based on a wakeup time of a node and a time interval that is consumed for transmitting a packet, and may be represented as t₀γ′+xγ′. Herein, xγ′ represents a standby time for preventing a packet collision, and xγ′ requests a standby time of a minimum of 3γ′. In an exemplary embodiment of the present invention, a range of x that is used for a standby time xγ′ is as follows.

3≦x≦X (Equation 2)

Schedule information is set according to an order of routing path branches that are stored within a path storage variable B_{sorted}, and a transmission schedule is set from a routing path branch in which the number of nodes is small.

In this way, schedule information including an initial value t₀ of a predetermined wakeup time T_{wakeup}, the node number N, and a hop count variable h, and a time point at which data transmitting/receiving is complete, is included in a message according to a preset form and is transmitted to each node.

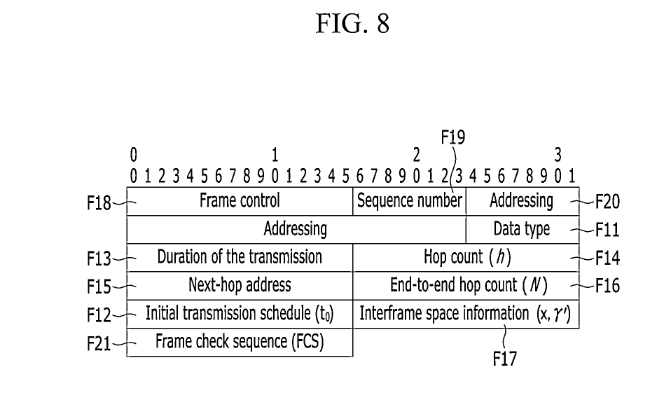

FIG. 8 is a diagram illustrating a structure of a schedule message according to an exemplary embodiment of the present invention.

A schedule message according to an exemplary embodiment of the present invention includes schedule information that is calculated by the sink node and includes a data field including the schedule information based on a MAC frame, as shown in FIG. 8.

The schedule message transmits transmitting and receiving schedule information of each node that the sink node calculates, and enables nodes within a network to transmit/receive data without collision at a time appropriate for multi-hop transmission.

A data type field F11 of a schedule message is a field that is used for classifying a data kind of a MAC payload, and an initial transmission schedule field F12 includes transmitting/receiving schedule information. The initial transmission schedule field F12 may include an initial value t₀ of a wakeup time T_{wakeup}, and this value may be represented based on a floating point of 2 bytes. For example, an initial transmission schedule field may be represented in a form of 32 bit single-precision and 64 bit double-precision that is defined in IEEE 754. However, such a form has too many bits when applying it to a wireless sensor network. Further, because schedule information always has a value larger than “0”, a bit to use when displaying a symbol is unnecessary. Therefore, schedule information follows a specification of a symbol, an exponent portion, and a mantissa portion forming a floating point, but by allocating 0 bits, 3 bits, and 13 bits to each configuration portion, a transmitting and receiving schedule value may be expressed with 0-128, and schedule information may have accuracy of at least 0.0001 sec.

A transmission field F13, a hop count field F14, and a next-hop address field F15 are included in a pioneer control (PION) frame, which is a control frame that is used for managing transmitting and receiving schedules in an R-MAC-based network. An end-to-end hop count field F16, the initial transmission schedule field F12, and an interspacing time information field F17 are added to a PION frame by a schedule method according to an exemplary embodiment of the present invention.

The initial transmission schedule field F12 includes tᵢₙᵢₜ corresponding to an initial value of a wakeup time T_{wakeup}, the end-to-end hop count field F16 includes the node number N, and the interspacing time information field F17 includes x and a time interval γ′ that is consumed when transmitting a packet. The hop count field F14 includes a hop count h.

In a PION frame of the existing R-MAC, overhead increases due to frequent PION transmission in a sensor network in which all nodes within a network transmit data to the sink node with a method in which a node to start transmission transmits data after a PION frame is transmitted. However, according to an exemplary embodiment of the present invention, the sink node transmits a message including schedule information to a terminal node of each routing path branch, and a random node on a transmitting path determines transmitting and receiving schedules according to information that is included in a received message.

A frame control field F18, a sequence number field F19, an addressing field F20, and a frame check sequence (FCS) field F21 are basically used in an existing MAC frame.

A structure of such a schedule message is an illustration and may be variously changed, and may be applied to a frame that is used in another network protocol.

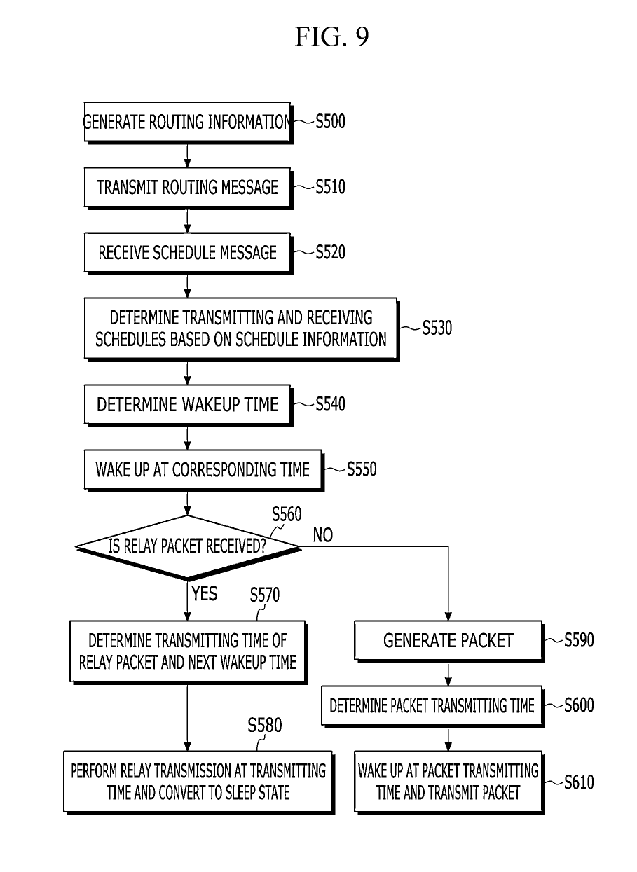

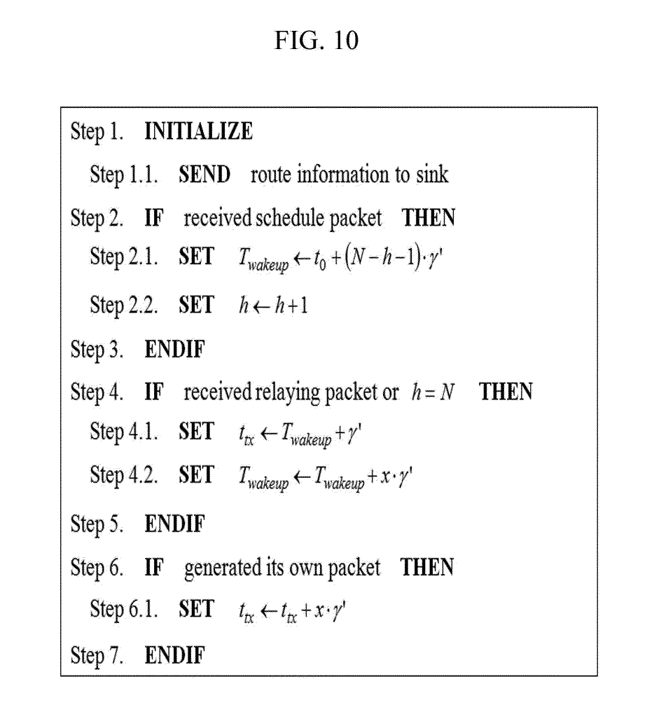

FIG. 9 is a flowchart illustrating a scheduling method that a general node performs according to an exemplary embodiment of the present invention, and FIG. 10 is a diagram illustrating a pseudo code representing operation of a general node according to the scheduling method of FIG. 9.

At an INITIALIZE step, each node of a sensor network transmits a message including routing information to the sink node based on a routing path according to a routing metric. Each node generates routing information including an address, an address of a parent node (upward node), and the information on the hop number to the sink node (S500), and transmits a message including the routing information to the sink node (S510).

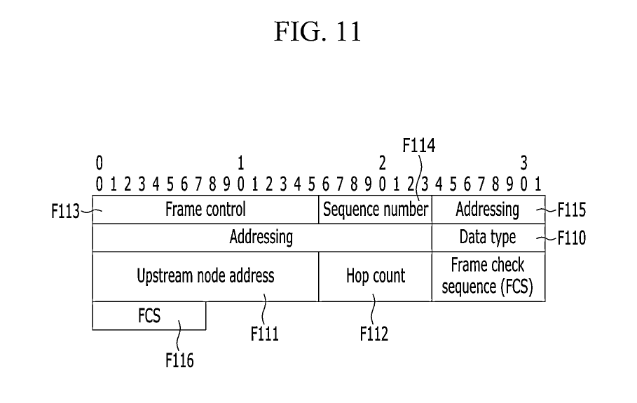

FIG. 11 is a diagram illustrating a structure of a routing message according to an exemplary embodiment of the present invention.

A routing message according to an exemplary embodiment of the present invention includes an upstream node and hop number information of a general node, and enables the sink node to grasp network characteristics.

As shown in FIG. 11, a routing message according to an exemplary embodiment of the present invention includes a data type field F110, an upstream node address field F111, and a hop count field F112.

The data type field F110 is used for distinguishing a data kind of a MAC payload, and the upstream node address field F111 is an address field of 2 bytes and includes information (address and identification information, for example an IP address and ID or an IP address and a MAC address) of an upstream node (or parent node). A frame control field F113, a sequence number field F114, an addressing field F115, and an FCS field F116 are basically used in an existing MAC frame.

An information exchange using a routing message may be performed in a process of exchanging a network forming initial routing message, and may be omitted when unnecessary according to a routing algorithm used.

A sink node calculates a transmission schedule based on routing information that is received from each node, as described above, and transmits a schedule message including schedule information corresponding thereto to each node.

A node, having received a schedule message from the sink node, determines transmitting and receiving schedules according to schedule information that is included in the received message (S520 and S530).

The node determines a wakeup time T_{wakeup} for transmitting and receiving data (S540). The wakeup time may be calculated as follows.

T_{wakeup}←t₀+(N−h−1)·γ′ (Equation 3)

The node increases a hop count h by a predetermined value (e.g., +1).

Each node wakes up at a wakeup time T_{wakeup} to detect a channel (S550), and while a packet is transmitted, each node receives a corresponding packet and performs relay transmission after a time interval γ′. Specifically, the node determines whether a packet, i.e., a relay packet, that should be transmitted to the sink node is received (S560), and if the packet, i.e., the relay packet, that should be transmitted to the sink node is received, the node sets a transmitting time tₜₓ of a relay packet that is received for relay transmission.

The transmitting time tₜₓ may be set as follows.

tₜₓ←T_{wakeup}+γ′ (Equation 4)

The node sets a schedule time, i.e., a wakeup time T_{wakeup}, for receiving a next packet (S570). A schedule time T_{wakeup} for receiving the next packet may be set based on a previous wakeup time and a standby time xγ′ for preventing a packet collision.

T_{wakeup}←T_{wakeup}+x·γ′ (Equation 5)

In this way, the node wakes up at a wakeup time T_{wakeup}, receives a packet, performs relay transmission of the packet that is received at a transmitting time tₜₓ for relay transmission, and converts to a sleep state (S580). Thereafter, the node wakes up at a schedule time T_{wakeup} for reception of a next packet.

When the node generates a data packet that should be transmitted to the sink node (S590), the node sets a time interval of a standby time x·γ′ from a previous data transmission time and transmits data. For this purpose, a transmitting time for transmitting a generated data packet may be set as follows (S600).

tₜₓ←tₜₓ+x·γ′ (Equation 6)

Each node wakes up at every standby time x·γ′ based on a T_{wakeup} time to transmit/receive a packet, and when a transmitting packet is not detected upon waking up, by stopping a wireless communication unit for a sleep cycle, power consumption can be reduced (S610).

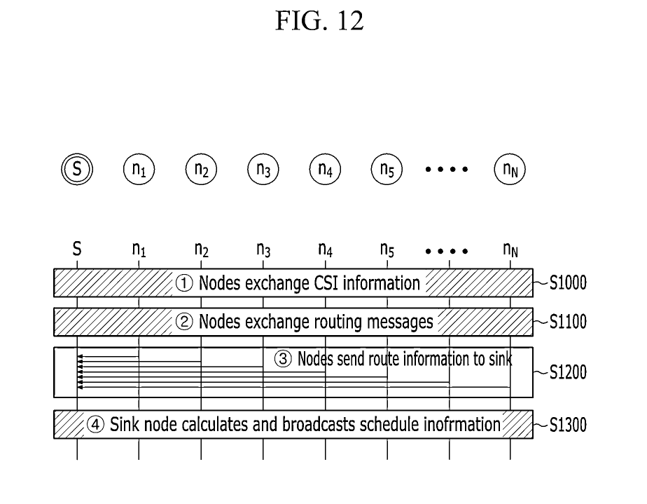

FIG. 12 is a message flowchart of a network in a scheduling method according to an exemplary embodiment of the present invention.

First, an information exchange of channel state information CSI between nodes constituting a sensor network is performed (S1000). Each node may transmit a packet with minimum transmitting power to satisfy a minimum SINR to an adjacent 1-hop node based on the channel state information.

Thereafter, each node performs a routing message exchange process in which a routing message is exchanged (S1100). Each node forms a route with such a routing message exchange. Next, each node transmits a routing message including routing information based on a route that is formed with a sink node to the sink node (S1200).

By grasping a network state based on routing information that is included in a received message, the sink node schedules a transmitting and receiving time of each node, as described above. The sink node transmits a message including schedule information to each node, and each node adjusts transmitting and receiving schedules thereof using the received schedule information (S1300).

When information exchange is available between nodes including the sink node in the routing forming step S1100 according to a routing protocol used, a process S1200 of transmitting routing information to the sink node may be omitted.

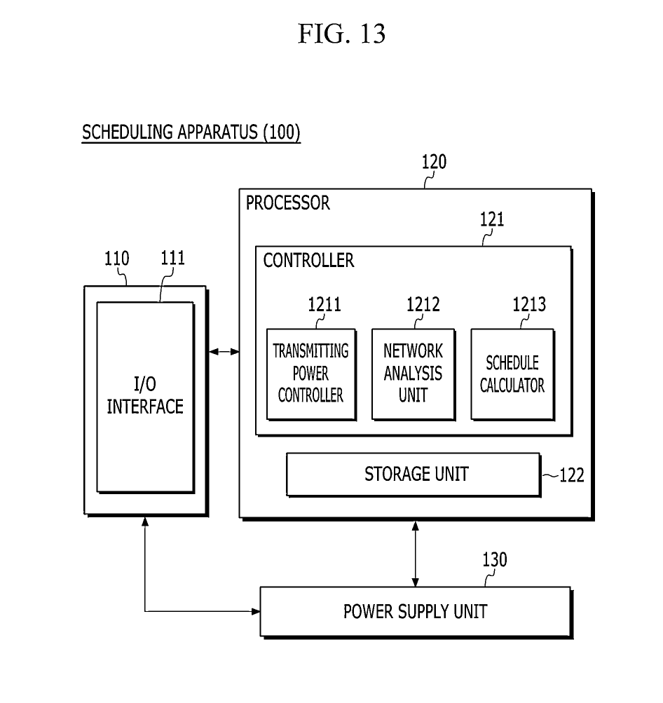

FIG. 13 is a block diagram illustrating a structure of a scheduling apparatus according to an exemplary embodiment of the present invention.

A scheduling apparatus 100 according to an exemplary embodiment of the present invention includes a wireless communication unit 110, a processor 120 that calculates schedule information, and a power supply unit 130.

The wireless communication unit 110 includes an input/output interface (I/O Interface) 111 for transmitting with a periphery node. The wireless communication unit 110 transmits data that the processor 120 designates according to a configuration in which the processor 120 sets and forwards the received data to the processor 120.

The processor 120 includes a controller 121 and a storage unit 122. The controller 121 performs a transmitting output control function, a network structure analysis function, and a network scheduling function of the wireless communication unit. For this purpose, the controller 121 includes a transmitting power controller 1211 that sets minimum transmitting power to satisfy a minimum SNIR of a 1-hop node based on channel state information CSI that is provided from nodes and that controls the wireless communication unit 110 based on the minimum transmitting power. Further, the controller 121 includes a network analysis unit 1212 that analyzes a network structure based on routing information that is received from nodes. Further, the controller 121 includes a schedule calculator 1213 that calculates the node number of each routing path branch that is acquired based on a network structure and that calculates a transmission schedule in order of a branch having the small node number. The schedule calculator 1213 generates schedule information including tᵢₙᵢₜ corresponding to an initial value of a wakeup time T_{wakeup} of a node, the node number N, a time interval γ′ that is consumed for transmitting a packet, and a gap multiple x, and the hop count number h on each branch basis.

The controller 121 processes data to be transmitted, forwards the data to the wireless communication unit 110, and stores the received packet at the storage unit 122, thereby enhancing efficiency of processing.

Power is supplied to the wireless communication unit 110 and the processor 120 through the power supply unit 130.

A scheduling apparatus according to an exemplary embodiment of the present invention is not limited to the above structure and may be variously changed.

Hereinafter, a data transmission process of a case that applies a transmission scheduling method according to an exemplary embodiment of the present invention to a network will be described.

In a network of a tandem structure that is formed with one sink node and a plurality of nodes, scheduling in which the sink node receives all data from all nodes is described as follows.

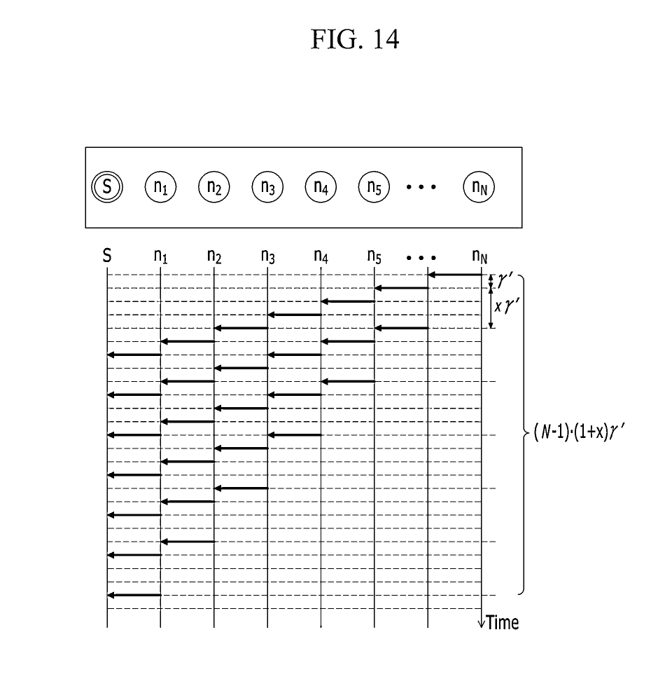

FIG. 14 is a diagram illustrating data transmission timing when a scheduling method is applied to a sensor network of a tandem structure according to an exemplary embodiment of the present invention.

When an N-th node that is positioned at a terminal in a sensor network starts data transmission, data is transmitted to the sink node with multi-hop transmission through relaying. In this case, in relay transmission, a time interval of γ′ exists, and a value of γ′ is varied according to whether ACK is replied, as described above.

A time T_{SLEEP} that is consumed until the N number of nodes transmit data to the sink node is as follows.

T_{SLEEP}=(N−1)·(1+x)·γ′ (Equation 7)

Each node operates based on CSMA or CSMA/CA, but in a sleep period (a sleep period represents a segment in which actual data transmission is performed) through scheduling, each node operates similar to time slot-based time-division multiple access (TDMA) in which one size is γ′.

In this case, in order to prevent colliding with a packet that a hidden node transmits, when a specific node transmits data, data transmission of nodes within adjacent predetermined hops (e.g., 2 hops) as well as an adjacent node is prohibited. Therefore, each node according to an exemplary embodiment of the present invention performs data transmission at a gap of the predetermined hop number (e.g., 2 hops).

For example, when a node n₂ transmits data, nodes n₃ and n₄ within 2 adjacent hops do not transmit data, and data may be transmitted from a node n₅. In this case, when the N number of nodes transmit data to the sink node, a time interval of γ′ is consumed at every transmission, and due to a packet collision avoidance problem, after a node transmits data, in order for an adjacent node n_{(N-1)} to transmit data, it is necessary to additionally stand by for a time of xγ′. A minimum value of a standby time xγ′ is 3γ′, and a standby time of the maximum Xγ may be allocated.

Therefore, in a tandem network that is formed with one sink node and the N number of general nodes, in order for the general node to perform multi-hop relay transmission of data and in order for the sink node to receive all data, in relay transmission, as shown in FIG. 13, a time of (N−1)·(1+x)·γ is consumed.

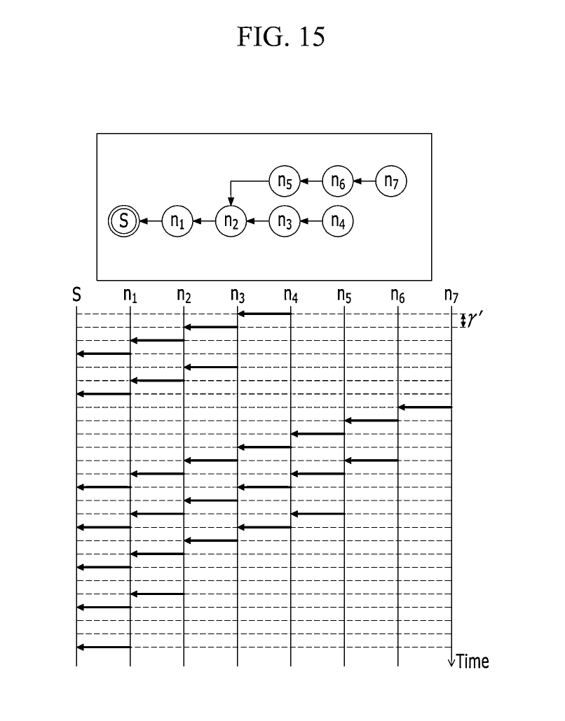

FIG. 15 is a diagram illustrating data transmission timing when a scheduling method is applied to a sensor network having a bonding node according to an exemplary embodiment of the present invention.

In a sensor network having a bonding node and branches that are connected thereto such as a water environment management network, the sink node determines a transmission schedule by giving a higher priority order to a branch having the smaller node number to each routing path branch, as described above. For example, as shown in FIG. 14, for two branches following, which is a bonding node n₂, a first branch that is formed with nodes n₃˜n₄ has a smaller node number than that of a second branch that is formed with nodes n₅˜n₇, and thus the first branch has a higher priority order in transmitting. Further, each branch within a network forms a tandem structure in which an ending node is a bonding node. Therefore, a scheduling method is applied, as described above, and thus as shown in FIG. 14, each node operates.

That is, as shown in FIG. 15, for the first branch having a high priority order, data is transmitted based on a scheduling method as shown in FIG. 14, and after data transmission of all nodes that are included in the first branch is complete, for a second branch having a next priority order, data is transmitted based on a scheduling method as shown in FIG. 14.

As described above, in a sensor network having a linear node disposition or a tree form node disposition that is connected with a multi-hop, such as a water environment sensor network, all sensor nodes should transmit each sensing information to a sink node. In such a situation, in linear node disposition, because a node adjacent to a sink node should accumulate and relay sensing information that is relayed from a far distance, many loads are applied, and when too large a time interval is set for relay transmission of each node in consideration of this, an problem of an increased delivery latency time occurs. Further, in node disposition of a tree form, in a junction node that is positioned at the center, because packets that are relayed from other branches are simultaneously converged, many loads are applied. Therefore, in an exemplary embodiment of the present invention, in linear node disposition, a transmission schedule may be followed to minimize time latency and to minimize interference between relay nodes. In node disposition of a tree form, a transmission schedule that can reduce a load of a junction node can be followed.

According to an exemplary embodiment of the present invention, in a wireless sensor network in which nodes are disposed in a linear or tree form requiring multi-hop relay transmission, because delivery latency can be reduced, quality of time latency performance of multi-hop transmission can be secured. Further, in a wireless sensor network in which a junction node exists, packet damage due to a traffic overload of the junction node can be minimized.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a sink node performs transmission scheduling in a sensor network comprising the sink node and a plurality of sensor nodes, the method comprising:
receiving, by the sink node, a routing message comprising routing information from the sensor nodes;
analyzing, by the sink node, a structure of the sensor network based on the routing information and calculating a transmission schedule of each sensor node based on the analyzed network structure; and
transmitting a schedule message comprising schedule information according to the calculated transmission schedule to the sensor nodes,
wherein the schedule information comprises a wakeup time of the sensor node, a time interval that is consumed for transmitting a packet, and a standby time for preventing a packet collision based on the time interval.

2. The method of claim 1, wherein the schedule information further comprises a hop number and a node number from the sensor node to the sink node.

3. The method of claim 1, wherein the standby time is xγ′, where γ′ represents a time interval and x satisfies a condition Of 3≦x≦X.

4. The method of claim 1, wherein the calculating of a transmission schedule comprises,
when the sensor network comprises a plurality of routing path branches based on a junction node:
calculating the node number on a routing path branch basis; and
calculating a transmission schedule on a routing path branch basis according to a priority order based on the node number.

5. The method of claim 4, further comprising calculating a transmission schedule of sensor nodes that are included in each branch in order from a branch having the smallest node number.

6. The method of claim 1, wherein the schedule message is formed based on a pioneer frame (PION frame) structure, and comprises an initial transmission schedule field comprising an initial value of a wakeup time of the sensor node, an interfacing time information field comprising a time interval and a standby time that are consumed for transmitting a packet, and a hop count field representing an end-to-end hop number.

7. A method in which a sensor node performs transmission scheduling in a sensor network comprising a sink node and a plurality of sensor nodes, the method comprising:
receiving, by a sensor node, a schedule message comprising schedule information from the sink node; and
determining a wakeup time for transmitting/receiving data based on the schedule information,
wherein the schedule information comprises an initial value of a wakeup time of the sensor node, a time interval that is consumed for transmitting a packet, and a hop number and a node number from the sensor node to the sink node.

8. The method of claim 7, wherein in the determining of a wakeup time,
the wakeup time is determined as T_{wakeup}←t₀+(N−h−l)·γ′, where γ′ is a time interval, N is the node number, t₀ is the initial value, and h is the hop number.

9. The method of claim 7, further comprising:
waking up, by the sensor node, at the wakeup time and detecting a channel;
determining, when a packet to perform relay transmission exists at the channel, a transmitting time of the relay packet; and
determining a schedule time to receive a next packet.

10. The method of claim 9, wherein the determining of a transmitting time comprises determining the transmitting time based on the determined wakeup time and the time interval, and
the determining of a schedule time comprises determining the schedule time based on the determined wakeup time and the standby time.

11. The method of claim 9, further comprising, after the waking up at the wakeup time,
determining, when the sensor node generates a packet to transmit, a transmitting time for transmitting the generated packet,
wherein a transmitting time for transmitting the generated packet is determined based on the standby time.

12. The method of claim 7, wherein a sensor node that is positioned at a terminal of the sensor network first starts data transmission, and adjacent sensor nodes existing within the predetermined hop number from a sensor node that performs data transmission do not perform data transmission when the sensor nodes are disposed in a linear structure in the sensor network.

13. The method of claim 7, wherein data transmission is performed in order of a branch having the smallest node number, and after data transmission of sensor nodes belonging to a random branch is complete, data transmitting of sensor nodes belonging to a branch of a next order is performed, when sensor nodes are disposed while forming at least one branch based on a junction node according to a tree structure in the sensor network.

14. The method of claim 7, further comprising transmitting, by the sensor node, a routing message comprising routing information to the sink node, before receiving of a schedule message,
wherein the routing information comprises the transmitting hop number to the sink node according to a routing path, an address or identification information of the sensor node, and identification information of an upward node.

15. A scheduling apparatus that performs transmission scheduling in a sensor network comprising a sink node and a plurality of sensor nodes, the scheduling apparatus comprising:
a wireless communication unit that performs communication with nodes that are positioned at a periphery;
a transmitting power controller that determines transmitting power of the wireless communication unit based on channel state information that is provided from nodes;
a network analysis unit that analyzes a network structure based on routing information that is received from nodes; and
a schedule calculator that calculates a node number on a routing path branch basis that is acquired based on a network structure and that calculates a transmission schedule in order of a branch having the smallest node number.

16. The scheduling apparatus of claim 15, wherein the schedule calculator generates schedule information comprising a wakeup time of a sensor node, a time interval that is consumed for transmitting a packet, and a standby time for preventing a packet collision based on the time interval and transmits the schedule information to the sensor node through the wireless communication unit.

17. The scheduling apparatus of claim 15, wherein the routing information comprises a transmitting hop number to the sink node according to a routing path, an address or identification information of the sensor node, and identification information of an upward node, and
the network analysis unit acquires routing path branches that are connected to a junction node based on the routing information.
